(19) United States
(12) Patent Application Publication
(10) Pub. No.: US 2022/0351061 A1
(43) Pub. Date: Nov. 3, 2022

(54) SYSTEM AND METHOD FOR EDGE INFERENCE

(71) Applicant: Core Scientific Operating Company, Bellevue, WA (US)

(72) Inventor: Devon Baldwin, Black Diamond, WA (US)

(21) Appl. No.: 17/727,192

(22) Filed: Apr. 22, 2022

Related U.S. Application Data
(60) Provisional application No. 63/181,638, filed on Apr. 29, 2021.

(51) Int. Cl. G06N 5/04

(52) U.S. Cl. CPC G06N 5/046

(57) ABSTRACT

Systems and methods for selectively applying inference models on one or more edge devices in response to actual or predicted delays are disclosed. Inference models may be trained and deployed to a server and a first edge device. Sensor data may be received at the server and may also be forwarded to the first edge device. A first inference may be performed on the server by applying the data to the trained inference model to generate a first inference result. The results may be sent to the first edge device. In response to not receiving the first inference result at the first edge device after a delay threshold or in response to a queue length on the server exceeding a threshold, an inference may be performed on the first edge device using the received sensor data. Inference results from the server and the edge device may be combined and reordered.

### CROSS-REFERENCE TO RELATED APPLICATION

This application claims the benefit of and priority to U.S. Provisional Patent Application Ser. No. 63/181,638, filed on Apr. 29, 2021, the disclosure of which is hereby incorporated by reference in its entirety as though fully set forth herein.

### TECHNICAL FIELD

The present disclosure generally relates to data processing, and more specifically to applying inference models on edge devices.

### BACKGROUND

This background description is set forth below for the purpose of providing context only. Therefore, any aspect of this background description, to the extent that it does not otherwise qualify as prior art, is neither expressly nor impliedly admitted as prior art against the instant disclosure.

With increasing processing power becoming available, machine learning (ML) techniques can now be used to perform useful operations such as translating speech into text. This may be done through a process called inference, which runs data points such as real-time or near real-time audio streams into a machine learning algorithm (called an inference model) that calculates an output such as a numerical score. This numerical score can be used for example to determine which words are being spoken in a stream of audio data.

The process of using inference models can be broken up into two parts. The first part is a training phase, in which an ML model is trained by running a set of training data through the model. The second is a deployment phase, where the model is put into action on live data to produce actionable output.

In many deployments, the inference model is typically deployed to a central server that may apply the model to a large number of data streams (e.g., in parallel) and then transmit the results to a client system. Incoming data may be placed into one or more queues where it sits until the server's processors are able to run the data through the inference model. When too much incoming data is received at one time, the queues may increase in length, leading to longer wait times and unexpected delays for the data in the queues. For data streams requiring real-time or near real-time processing, these delays can be problematic.

While implementations running inference models in cloud instances can be scaled up (up to a point), instances running in secure dedicated environments (e.g., bare metal systems) cannot scale up as easily. Once available capacity is exceeded, delays will result. For at least these reasons, an improved system and method for inference is desired.

The foregoing discussion is intended only to illustrate examples of the present field and is not a disavowal of scope.

### SUMMARY

The issues outlined above may at least in part be addressed by selectively applying inference models on one or more edge devices in response to actual or predicted delays. In one embodiment, the method for processing data may comprise using inference models that are trained and deployed to a server and a first edge device (e.g., a smart phone or PC or mobile device used by a customer service agent in a call center). Sensor data from a second edge device (e.g., a customer's mobile phone or a car's autonomous navigation system) such as audio data, image data, or video data may be received at the server and at the first edge device. A first inference may be performed on the server by applying the data to the trained inference model to generate a first inference result, and the results may be sent to the first edge device (e.g., to assist the customer service agent in resolving the customer's issue). In response to not receiving the first inference result at the first edge device after a predetermined delay threshold, a second inference may be performed on the first edge device using the sensor data that was received.

There are many uses for inference models. In the case of voice data, some uses are inferring a text translation or the emotional state of the user if the sensor data is voice data. This may for example be used to assist a customer service agent in understanding someone with an accent that is difficult for them, or it may be used to automatically escalate a call to a manager when a customer's voice tone indicates a stress level indicative of frustration or anger. One example using image or video data is inferring a license plate number from data captured by a parking enforcement vehicle, and the system may in real time or near real-time provide this information to an agent along with associated data such as how long the vehicle has been in its current location or whether it has any outstanding parking tickets and should be booted.

In some embodiments, the data received at the server may be placed in one or more queues while it awaits processing at the server. In response to the queue being shorter than a predetermined threshold, inference using a trained inference model may be performed on the data on the server to generate a first result. In response to the queue being longer than the predetermined threshold, the trained inference model may be deployed to a second device (if it has not already been deployed), and the data may also be sent to the second device with instructions to perform an inference to generate a second result. The second device may for example be an edge device or a mobile phone. In some embodiments, the data may be automatically forwarded or provided directly to the second device, which may cache it for a period of time in case the queue length exceeds the threshold.

Edge devices may not have enough computing power, battery life, or memory to constantly perform inferences, but they may have enough to apply the trained inference model selectively for limited periods of time when the server is becoming overwhelmed. In some embodiments, a simplified inference model may be deployed to the edge devices (rather than the full model designed for the processing power and capabilities of the server).

In another embodiment, the method comprises training an inference model and deploying it to a first computer, creating a queue on the first computer, receiving a first set of data from a first device in the first queue and predicting a wait time for the queue. Once through the queue, the first set of data is applied to the inference model on the first computer, and results are sent to a second device. In response to the predicted wait time for the queue being greater than a predetermined threshold, the inference model may be deployed to the second device where a second queue is created. At least a portion of subsequent sets of data may then be directed to the second queue in lieu of the first queue.

In some embodiments, a first stream of inference results generated on the first computer may be forwarded to the second device. A second stream of inference results may be generated on the second device; and the results in the first and second streams may be ordered/reordered on the second device (e.g., to preserve time-based ordering based on the timing of the sets of data).

In another embodiment, the method may comprise training an inference model, deploying the inference model to a first computer, creating a first queue on the first computer, receiving a first set of data captured by a sensor on a first device in the first queue, performing a first inference on the first computer to generate a first result, sending the first result to a client, predicting a wait time for the first queue, and, in response to the predicted wait time being greater than a predetermined threshold, deploying the inference model to the first device, and instructing the first device to apply the inference model to at least a subset of subsequent data captured by the sensor and send subsequent results to the client. The results may then be ordered based on a sequence id (e.g., a timestamp).

The foregoing and other aspects, features, details, utilities, and/or advantages of embodiments of the present disclosure will be apparent from reading the following description, and from reviewing the accompanying drawings.

### BRIEF DESCRIPTION OF THE DRAWINGS

FIG. 1 is a schematic view generally illustrating an example of a system for performing edge inference according to teachings of the present disclosure.

FIG. 2 is a flow diagram generally illustrating an example of a method for performing edge inference according to teachings of the present disclosure.

FIG. 3 is a flow diagram generally illustrating another example of a method for performing edge inference according to teachings of the present disclosure.

FIG. 4 is a flow diagram generally illustrating yet another example of a method for performing edge inference according to teachings of the present disclosure.

### DETAILED DESCRIPTION

Reference will now be made in detail to embodiments of the present disclosure, examples of which are described herein and illustrated in the accompanying drawings. While the present disclosure will be described in conjunction with embodiments and/or examples, it will be understood that they do not limit the present disclosure to these embodiments and/or examples. On the contrary, the present disclosure covers alternatives, modifications, and equivalents.

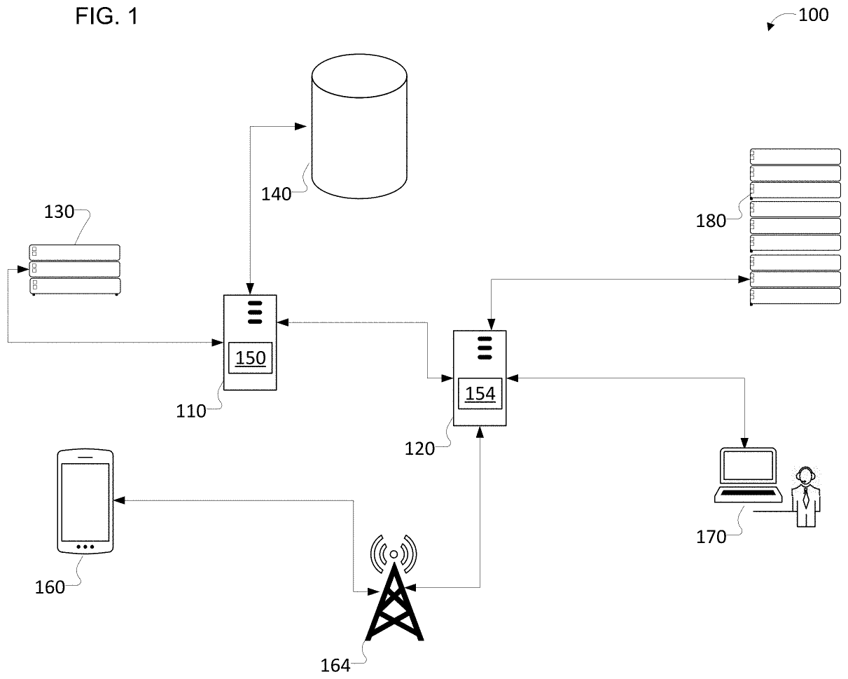

Turning now to FIG. 1, a schematic view generally illustrating an example of a system 100 for performing edge inference according to teachings of the present disclosure is shown. In this embodiment, an inference model is trained by training computer 110 using a training program 150. The inference model may rely on a set of training data 140 that is applied to the model using a set of processors in a training cluster 130. Additional data may be added to training data 140 (e.g., periodically over time). Training is the process of teaching deep neural networks (DNN) to perform a desired artificial intelligence (AI) task (such as image classification or converting speech into text) by feeding it data, resulting in a trained deep learning model. Once trained, the model can be used to make inferences about incoming data (e.g., identifying an image, translating speech to text, translating one language to another, detecting stress levels in a voice, etc.).

The trained inference model 154 may be deployed to a computer such as server 120, configured with processing resources 180 to support performing inference on a large amount of production data (e.g., voice, image or media data) from a device 160 (e.g., a remote or edge device such as a mobile phone) that communicates with the server 120 via a wireless network such as cellular network 164. This may be useful for example in instances where server 120 provides support to an application running on another edge device 170 (e.g., a PC or laptop or phone used by a customer service representative). In these support applications, the customer support representative may be communicating with the user of device 160 (e.g., a remote or edge device) while server 120 provides inference results to the customer service representative via device 170. For example, the server may process voice data coming from device 160 and in response to inferring an elevated level of stress in the voice data from device 160, that inference data may be provided to a program running on device 170 which may assist the customer service representative accordingly (e.g., by automatically transferring the irate caller to a manager). Another example might be one where device 160 is mounted on a parking meter checking vehicle and sending a stream of video data to server 120, which infers license plate numbers from the video stream. The license plate numbers may then for example be provided to a support center where a support agent or application operating on device 170 has access to additional relevant data such as outstanding parking tickets and can then make decisions using the results of the inference that may be provided back to the user of device 160.

In traditional configurations, trained inference models are executed on server 120 using processing resources 180 and the results are forwarded to device 170. Queues may be set up on server 120, as multiple edge devices such as device 160 may be sending data to server 120 in parallel. As noted above, this can lead to delays as the length of the queues grow. As the processing power of edge devices 170 has grown, some of these devices are now capable of performing inference (e.g., applying data to trained inference models) in real time or near real time. However, many of these edge devices are not practical for performing full time inference due to limitations such as battery life, processing power, memory limitations, and power supply limitations. For this reason, in some embodiments, edge device 170 may selectively perform inferences in response to delays experienced by server 120 (or delays in receiving the results from server 120 at device 170 or device 160). In some embodiments, data from device 160 may be forwarded from server 120 in response to the queue exceeding a certain threshold. In other embodiments, data from device 160 may be forwarded to device 170 in addition to server 120, and device 170 may selectively perform inferences in response to inference results from server 120 not being received within a predetermined delay threshold. Additional details of this process are described below.

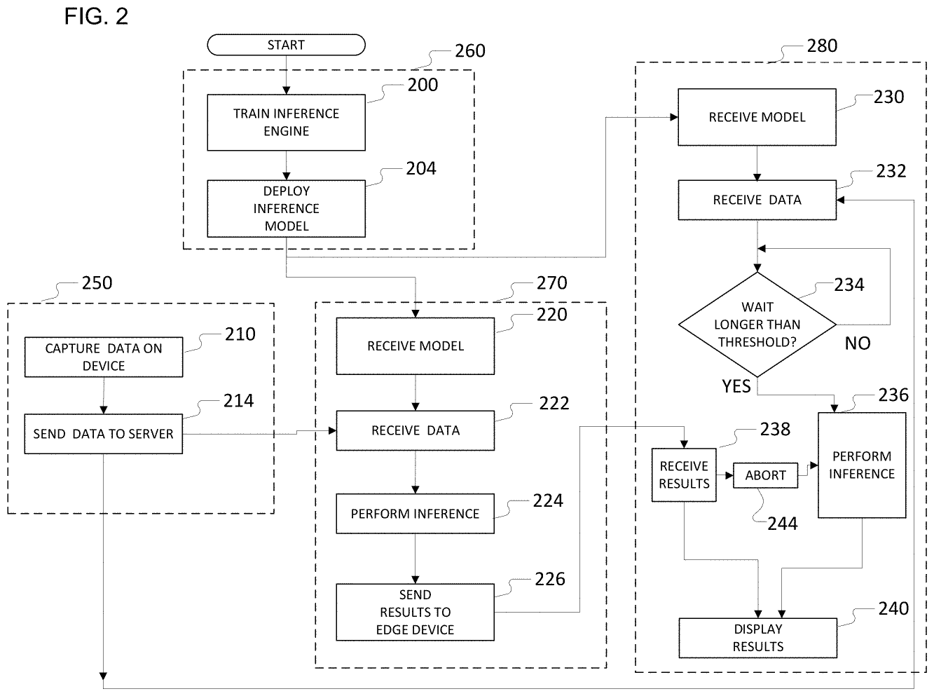

Turning now to FIG. 2, a flow diagram view generally illustrating an example of a method for performing edge inference according to teachings of the present disclosure is shown. In this embodiment, an inference model is trained (step 200) and then deployed (step 204). As indicated in the figure, these steps may be performed on a training computer 260. Training computer 260 may for example be a bare metal server or a virtual machine or container running in a cluster environment.

Production sensor data is captured (step 210) on a device 250 such as a mobile device, edge device, cell phone, or embedded device. For example, the navigation subsystem of an autonomous vehicle or a parking enforcement system or toll collection system may be configured with a camera to capture image or video data containing automobile license plates. The data captured may be sent to a computer 270 (e.g., a central server) and also to another edge device 280 (step 214). The computer 270 may be configured to receive the trained model (step 220), receive the collected sensor data (step 222), and perform an inference (step 224) to generate a result that is sent (step 226) to the edge device 280, which may receive result(s) (step 238).

The edge device 280 (e.g., a customer service representative's smart phone or terminal running a customer support software program that interfaces with computer 270) may be configured to receive the trained inference model (step 230) and receive sensor data (step 232) from device 250. If the wait time (e.g., delay) to receive the inference results from computer 270 is longer then a threshold (step 234), e.g., two seconds, the edge device 280 may be configured to perform its own inference (step 236) and then display the results (step 240). If the results are received from computer 270 prior to its inference being completed, the computing device 280 may in some embodiments be configured to ignore or abort (step 244) its inference and proceed with displaying the results from computer 270. In other embodiments, the local inference results may be preferred once the local edge inference has started.

The inference results may for example be the output of the inference model (e.g., text in a speech to text application, or a license plate number in a license plate recognition application), or additional processing may also be performed. For example, conditional logic based on the results of the inference model may be applied, such as looking up and displaying a make and model of the car and a list of parking tickets based on the recognized license plate number.

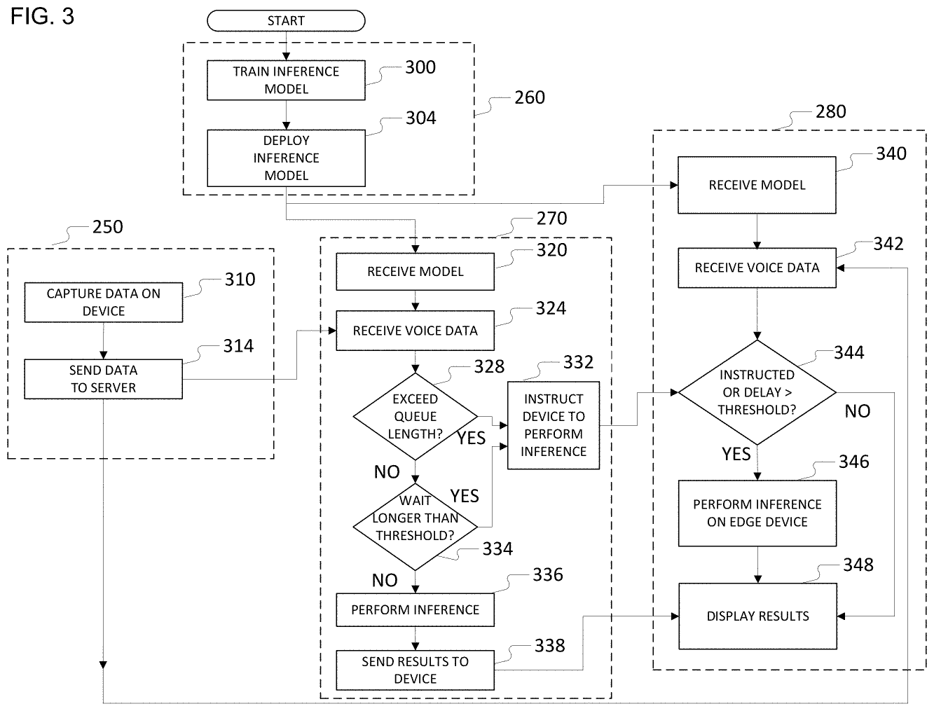

Turning now to FIG. 3, a flow diagram view generally illustrating another example of a method for performing edge inference according to teachings of the present disclosure is shown. In this embodiment, an inference engine is once again trained (step 300) and then deployed (step 304). As indicated in the figure, these steps may be performed on a training computer 260. Sensor data is captured (step 310) on device 250, and it is sent to computer 270 (e.g., a central server) and/or edge device 280 (step 314). In this embodiment, the model is received (step 320) at the computer 270, and the sensor data is received (step 324) in a data queue. If the queue length is greater than a predetermined length (step 328), or if a measured or predicted wait time is longer than a predetermined threshold (step 334), then computer 270 may instruct edge device 280 to perform its own inference (step 332). If not, computer 270 may perform the inference (step 336) and send the inference results (step 338) to device 280 (and or device 250).

Device 280 may be configured to receive a trained inference model (step 340) and sensor data such as voice data (step 342) from device 250. If device 280 is instructed to perform an inference or experiences a delay greater than a predetermined threshold in waiting for the inference results (step 344), it may proceed with performing its own inference (step 346). Once the device has the results (either generated by itself or by computer 270), those results may be displayed (step 348).

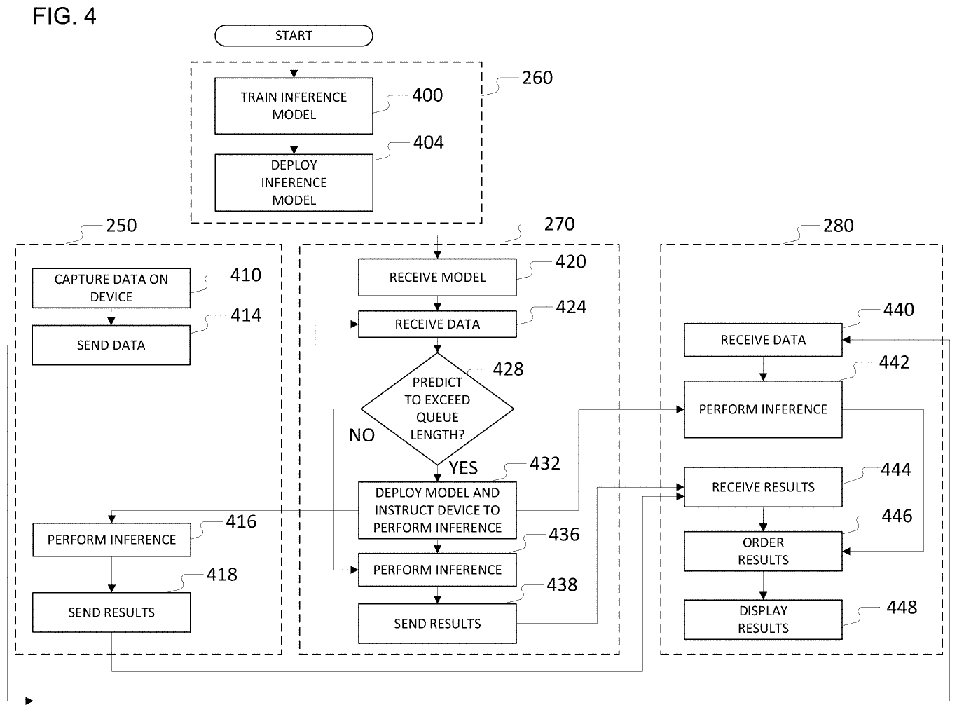

Turning now to FIG. 4, a flow diagram view generally illustrating yet another example of a method for performing edge inference according to teachings of the present disclosure is shown. In this embodiment, an inference engine is once again trained (step 400) and then deployed (step 404) from a training computer 260. Sensor data is captured (step 410) on a device 250, and it is sent to computer 270 (e.g., a central server) (step 414) and device 280. In this embodiment, the model is received (step 420) at the computer 270 and the device 280 (step 440), and the sensor data is received (step 424) in a data queue. If the queue length is greater than a predetermined length (step 428), then computer 270 may deploy the inference model to either or both edge devices 250 and 280 along with instructions to begin performing inference (step 432) on the edge device or devices. If not, computer 270 may perform the inference (step 436) and send the inference results (step 438) to device 280 (and/or device 250). This may prevent unexpected delays in generating inference results when queue lengths on computer 270 begin to exceed desired levels.

Device 250 may be configured to receive a trained inference model (step 416) from training computer 260 (e.g., via computer 270), and in response to in instruction to begin performing inference, send inference results to device 280 (step 418). If device 280 is instructed to perform an inference (or experiences is a delay greater than a predetermined threshold in waiting for the inference results), it may also proceed with performing its own inference (step 442). In this way the burden of applying the sensor data to the inference model may be transferred or distributed amongst one or more edge devices to prevent abnormally long inference wait times due to delays or excessive queue lengths at computer 270. Once the inference results are generated (either by an edge device or by computer 270), those results may be received (step 444) by the destination edge device 280, ordered (step 446) and displayed (step 448). Ordering may involve associating timestamps or sequence numbers with the sensor data and then keeping those timestamps or sequence numbers with the corresponding inference results. This may for example permit text data generated across computer 270 and edge devices 250 and 280 to be assembled in the proper order. Once the queue length drops below the desired level, the edge devices may be instructed by computer 270 to refrain from additional inference processing.

Various embodiments are described herein for various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments.

Reference throughout the specification to “various embodiments,” “with embodiments,” “in embodiments,” or “an embodiment,” or the like, means that a particular feature, structure, or characteristic described in connection with the embodiment is included in at least one embodiment. Thus, appearances of the phrases “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of embodiments.

Joinder references (e.g., attached, coupled, connected, and the like) are to be construed broadly and may include intermediate members between a connection of elements and relative movement between elements. As such, joinder references do not necessarily imply that two elements are directly connected/coupled and in fixed relation to each other. The use of “e.g.” in the specification is to be construed broadly and is used to provide non-limiting examples of embodiments of the disclosure, and the disclosure is not limited to such examples. Uses of “and” and “or” are to be construed broadly (e.g., to be treated as “and/or”). For example and without limitation, uses of “and” do not necessarily require all elements or features listed, and uses of “or” are inclusive unless such a construction would be illogical.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

All matter contained in the above description or shown in the accompanying drawings shall be interpreted as illustrative only and not limiting. Changes in detail or structure may be made without departing from the present disclosure.

It should be understood that a computer, a system, and/or a processor as described herein may include a conventional processing apparatus known in the art, which may be capable of executing preprogrammed instructions stored in an associated memory, all performing in accordance with the functionality described herein. To the extent that the methods described herein are embodied in software, the resulting software can be stored in an associated memory and can also constitute means for performing such methods. Such a system or processor may further be of the type having ROM, RAM, RAM and ROM, and/or a combination of non-volatile and volatile memory so that any software may be stored and yet allow storage and processing of dynamically produced data and/or signals.

It should be further understood that an article of manufacture in accordance with this disclosure may include a non-transitory computer-readable storage medium having a computer program encoded thereon for implementing logic and other functionality described herein. The computer program may include code to perform one or more of the methods disclosed herein. Such embodiments may be configured to execute via one or more processors, such as multiple processors that are integrated into a single system or are distributed over and connected together through a communications network, and the communications network may be wired and/or wireless. Code for implementing one or more of the features described in connection with one or more embodiments may, when executed by a processor, cause a plurality of transistors to change from a first state to a second state. A specific pattern of change (e.g., which transistors change state and which transistors do not), may be dictated, at least partially, by the logic and/or code.

What is claimed is:

1. A method for processing data, the method comprising:
(a) training an inference model;
(b) deploying the inference model to a server and a first edge device;
(c) receiving sensor data from a second edge device at the server and at the first edge device;
(d) performing a first inference on the server by applying the sensor data to the inference model to generate a first inference result;
(e) sending the first inference result to the first edge device; and
(f) performing a second inference on the sensor data on the first edge device in response to not receiving the first inference result at the first edge device after a predetermined delay threshold.

2. The method of claim 1, wherein the sensor data is audio data.

3. The method of claim 2, wherein the first inference and the second inference comprises inferring a text translation based on the audio data.

4. The method of claim 1, wherein the first inference and the second inference comprises inferring a stress level based on the sensor data.

5. The method of claim 1, wherein the sensor data is image data or video data.

6. The method of claim 1, further comprising aborting the second inference if the first inference result is received by the first edge device prior to the second inference being completed.

7. A method for processing data, the method comprising:
(a) receiving a first set of data from a first device in a queue for processing on a server;
(b) performing a first inference on the first set of data to generate a first result using a trained inference model in response to the queue being shorter than a predetermined threshold; and
(c) in response to the queue being longer than the predetermined threshold:
(i) sending the first set of data to a second device,
(ii) instructing the second device to perform a second inference on the first set of data to generate a second result.

8. The method of claim 7, wherein (c) further comprises deploying the trained inference model to the second device.

9. The method of claim 7, wherein the second device is an edge device or a mobile phone.

10. The method of claim 7, wherein the first set of data is audio data, image data, or video data.

11. The method of claim 10, wherein the first inference and the second inference comprise inferring a stress level based on the first set of data.

12. The method of claim 7, wherein the first inference and the second inference comprises inferring a text translation based on the first set of data.

13. The method of claim 7, further comprising caching the first set of data on the second device.

14. A method for processing data, the method comprising:
(a) training an inference model;
(b) deploying the inference model to a first computer;
(c) creating a first queue on the first computer;
(d) receiving a first set of data from a first device in the first queue;
(e) predicting a wait time for the first queue;
(f) applying the first set of data to the inference model on the first computer and sending results to a second device; and
(g) in response to the predicted wait time for the first queue being greater than a predetermined threshold:
(i) deploying the inference model to the second device;
(ii) creating a second queue on the second device; and
(iii) directing at least a portion of subsequent sets of data to the second queue in lieu of the first queue.

15. The method of claim 14, further comprising:
(h) generating a first stream of inference results on the first computer;
(i) forwarding the first stream of inference results to the second device;
(j) generating a second stream of inference results on the second device; and
(k) ordering the first stream of inference results and the second stream of inference results on the second device.

16. The method of claim 14, wherein the first set of data includes audio data, and wherein the inference model infers a text translation based on the audio data.

17. The method of claim 14, wherein the data is image data or video data.

18. A method for processing data, the method comprising:
(a) training an inference model;
(b) deploying the inference model to a first computer;
(c) creating a first queue on the first computer;
(d) receiving a first set of data captured by a sensor on a first device in the first queue;
(e) performing a first inference on the first computer to generate a first result;
(f) sending the first result to a client;
(g) predicting a wait time for the first queue; and
(h) in response to the predicted wait time being greater than a predetermined threshold:
(i) deploying the inference model to the first device, and
(ii) instructing the first device to apply the inference model to at least a subset of subsequent data captured by the sensor and send subsequent results to the client.

19. The method of claim 18, wherein (h) further comprises:
(iii) ordering the first stream of inference results from the first computer and the subsequent results from the first device at the client based on a sequence id.

20. The method of claim 19, wherein the sequence id is a timestamp.
